(19) United States
(12) Patent Application Publication
(10) Pub. No.: US 2009/0074539 A1
(43) Pub. Date: Mar. 19, 2009

(54) Fastener Assembly Requiring Low Torque For Fastening and Unfastening

(76) Inventor: Mohamad Ali Mahdavi, Solana Beach, CA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/854,928

(22) Filed: Sep. 13, 2007

(51) Int. Cl. F16B 43/00; B21D 39/00; B23P 11/00

(52) U.S. Cl. 411/533; 29/525.03

(57) ABSTRACT

A fastener assembly and a method of fastening are provided that require a low amount of torque for fastening two objects. The fastener assembly includes a key member having an end that may be aligned with apertures in the two objects. The fastener assembly also includes one or more springs that may be compressed to allow the end to be inserted into and through the apertures. Following insertion, the key member may be rotated through the application of a low torque such that its end is no longer aligned with the apertures. The springs may then be uncompressed to cause the springs and the non-aligned end to urge the two objects together.

### FIELD OF THE INVENTION

This invention relates to fasteners, and, more particularly, to fasteners requiring a low torque for actuating the fastener to join two objects together.

### BACKGROUND OF THE INVENTION

There are many different types of fasteners that are known in the art. For example, bolts, rods, pins, screws, and other fasteners have commonly been used to secure two objects to one another to form a complete assembly. Many of these fasteners, however, require the application of a relatively high amount of torque to actuate the fasteners. This torque requirement may make it difficult to actuate the fastener under certain circumstances. Further, this torque requirement may make many known types of fasteners impracticable for use with fragile components that cannot withstand the application of a large torque, i.e., that tend to break or become damaged when large torques are applied to them.

In addition, many common fasteners do not allow for the application of a predetermined amount of preload between the two objects. Preload, or the initial compressive force generated by a fastener, arises, in part, from the installation torque applied when the fastener is installed. Preload, however, also depends on other factors, such as frictional conditions and the nature of the coupling materials. Because much of the torque applied to many conventional fasteners is often used to overcome friction, even minor variations in frictional conditions can result in significant changes in preload. Accordingly, in many instances, the amount of preload applied to the fasteners is variable, i.e., is not applied consistently, and may result in insufficient or excessive forces acting against the fastener or mated objects. Insufficient preload is a common cause of joint failure. On the other hand, excessive preload may result in damage to the fastener or one or both of the mated objects.

Accordingly, there is a need for a fastener that requires little torque for securing two objects together and where fastening can be performed relatively quickly and easily. Further, there is a need for a fastener that allows for the accurate application of a predetermined amount of preload. There is also a need for a fastener that reduces the likelihood of either a low preload resulting in joint failure or a high preload that might result in damage to the fastener or to one or both objects being joined together. Further, there is a need for a method for conveniently actuating such a fastener using little torque.

### SUMMARY OF THE INVENTION

Several embodiments provide fastening structures and related methods of fastening objects together.

In one embodiment, a fastener assembly for fastening two objects having apertures therethrough, the fastener assembly comprises: a key member having a central axis about which the key member is capable of rotation, the key member having a first end and a second end, and further comprising a washer defining an opening therethrough for receiving a portion of the key member. The fastener assembly also includes at least one spring that is operatively coupled to the second end and that is biased to move longitudinally in a direction parallel to the central axis, wherein the second end is supported by the washer and is capable of rotation about the central axis.

In another embodiment, a method of fastening two objects together comprises the following steps: aligning apertures of two objects; positioning a fastener assembly having a key member with a first end and a second end, a washer and at least one spring such that the at least one spring is in abutting engagement with one of the objects and such that the first end is aligned with the apertures, wherein the second end is supported by the washer and the second end is operatively coupled to the at least one spring such that the second end and the at least one spring are moveable in a direction parallel to a central axis of rotation of the key member; applying a force against the washer to compress the at least one spring and to cause the first end to be inserted through the apertures; rotating the key member about the central axis such that the first end is not aligned with the apertures; and releasing the force applied to the washer such that the first end engages the other one of the objects and thereby causing the at least one spring and the first end to urge the two objects together along a direction parallel to the central axis.

### BRIEF DESCRIPTION OF THE DRAWINGS

FIG. 1 is a cross-sectional view of a fastener assembly embodying features of the present invention in a position in which two objects are secured together;

FIG. 2 is a bottom view of the fastener assembly securing two objects shown in FIG. 1;

FIG. 3 is a cutaway perspective view of the fastener assembly securing two objects shown in FIG. 1;

FIG. 4 is a perspective view of the fastener assembly of FIG. 1;

FIG. 5 is a perspective view of the fastener assembly of FIG. 1 without the springs;

FIG. 6 is an exploded top perspective view of the fastener assembly of FIG. 1; and

FIG. 7 is an exploded bottom perspective view of the fastener assembly of FIG. 1.

### DESCRIPTION OF THE PREFERRED EMBODIMENT

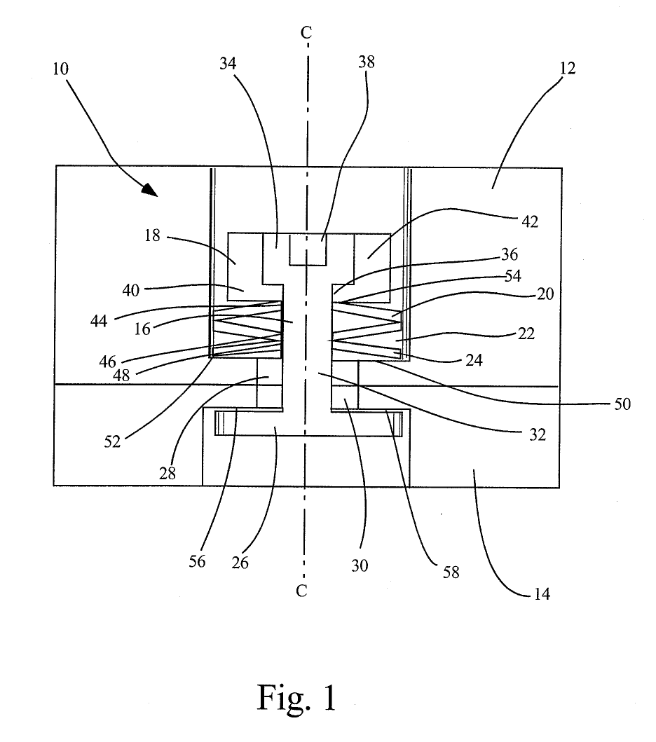

With reference to FIGS. 1-3, a preferred embodiment of a fastener assembly 10 is shown securing two objects together. The fastener assembly 10 is generally a twist lock device for joining two objects 12, 14 together and forming a mechanical joint therebetween. The objects 12, 14 may be completely discrete objects, such as two separate bodies, or may be separate components of a single body. The fastening is performed with a predetermined preload and fastening requires a relatively low torque.

As described further below, the fastener assembly 10 is operable between a first position, in which the assembly 10 is unfastened, and a second position, in which the assembly 10 fastens the two objects 12, 14 together. The fastener assembly 10 essentially operates through the insertion and rotation of a key-like portion to fasten and unfasten the two mated objects. The components of the assembly 10 are discussed below with reference to their orientation in the figures, but this discussion is not intended to impose any sort of limitation on orientation.

As can be seen in FIG. 1, the fastener assembly 10 generally includes a key member 16 that is rotatable about a central axis C-C, a washer 18, and one or more springs 20, 22, 24. The key member 16 is preferably substantially symmetrical about its central axis. Further, as described in greater detail below, the key member 16 generally includes a distal end 26 that is shaped for insertion into and through apertures 28, 30 in the objects 12, 14 when the distal end 26 and apertures 28, 30 are in alignment but that prevents insertion into and through the apertures when the distal end 26 and apertures 28, 30 are not in alignment. Insertion and rotation of the distal end 26 permits fastening and unfastening of the fastener assembly 10.

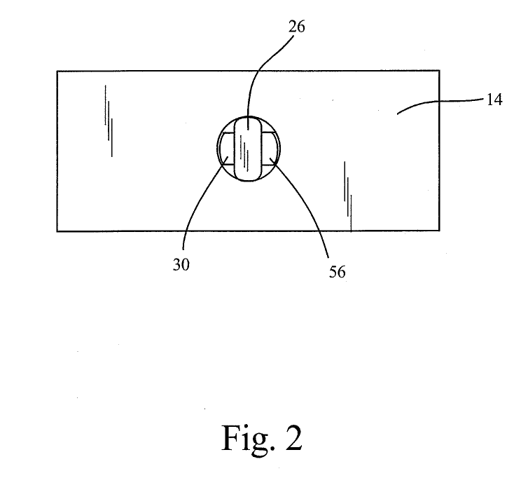

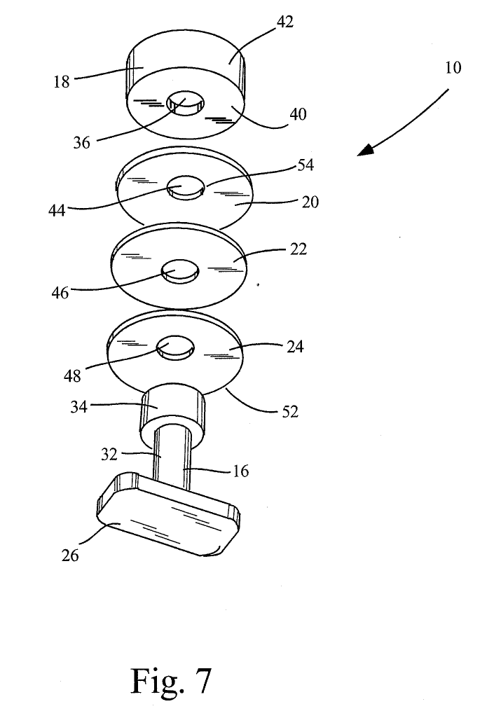

As shown in FIGS. 1, 6, and 7, the key member 16 preferably has a distal end 26, a shaft 32, and a proximal end 34. The distal end 26 preferably has a substantially rectangular cross-section and is perpendicular to the central axis such that it forms a “T” shape in combination with the shaft 32. The apertures 28, 30 are preferably in the form of slots. The distal end 26 is moveable longitudinally and acts like a key to fasten and unfasten the two objects 12, 14. The distal end 26 is sized such that its width and length are smaller than the width and length of the apertures 28, 30, respectively, so that it may be inserted downwardly through the apertures 28, 30. After insertion, the distal end 26 is disposed beneath the apertures 28, 30. The distal end 26 is further sized such that its length is wider than the width of the apertures 28, 30 so that it will not move through the apertures 28, 30 when rotated 90° following insertion, as shown in FIG. 2.

Although the distal end 26 is preferably in the shape described above, it may also any of various other shapes. For example, the distal end 26 may also be in the shape of a polygon other than a rectangle, such as a polygon having three or five sides, etc. In this example, the apertures 28, 30 would preferably have a similar corresponding polygonal shape such that the distal end 26 would be capable of insertion into and through the apertures 28, 30. Further, in this example, the distal end 26 would not be free to move back through the apertures 28, 30 following insertion through the apertures 28, 30 and subsequent rotation of the distal end 26 a predetermined amount.

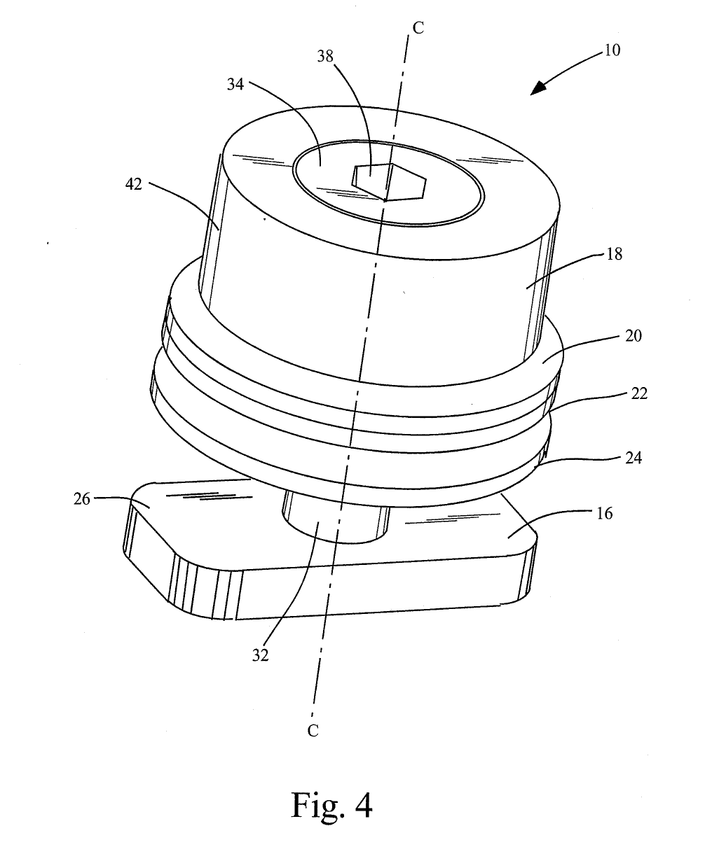

As can be seen from FIGS. 4-7, the shaft 32 is received within the washer opening 36 and joins the distal and proximal ends 26, 34 of the key member 16. Following insertion of the distal end 26, the shaft 32 extends upwardly from the distal end 26 and extends through the apertures 28, 30 defined by the two objects 12, 14. The shaft 32 preferably has a circular cross-section with the center located along the central axis C-C. The shaft 32, however, may be any of various cross-sections and dimensions, as long as the shaft 32 is sized so that it is freely rotatable when inserted into the apertures 28, 30.

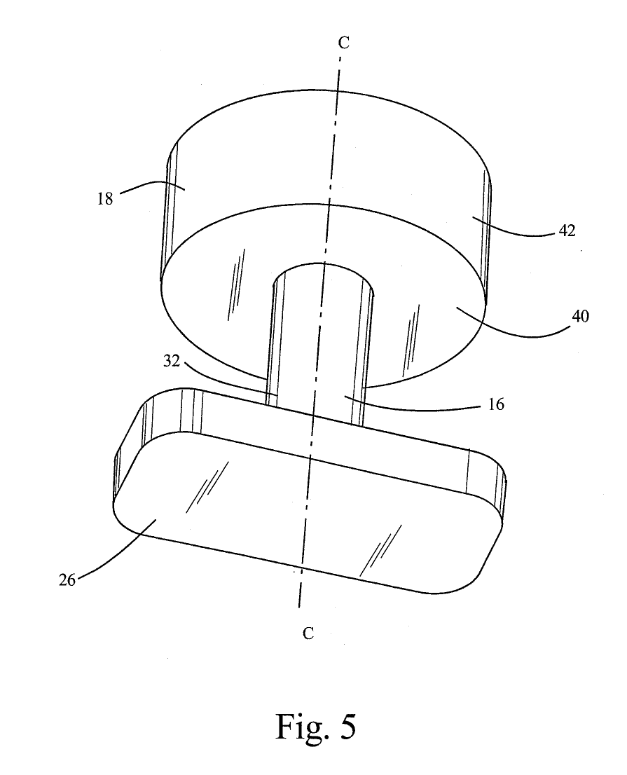

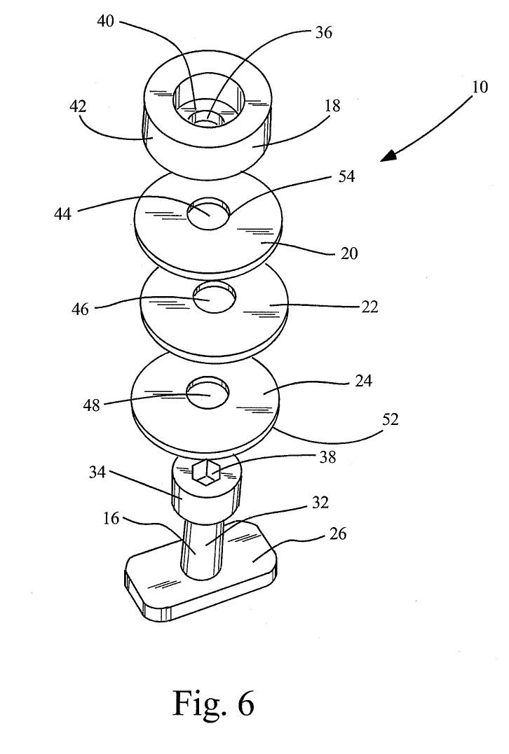

The proximal end 34 is substantially cylindrical in shape having a cross-section that is larger than the washer opening 36 to keep the proximal end 34 positioned above the base of the washer 18. The proximal end 34 preferably includes a recess 38 in its top surface to allow the insertion of a tool head to effect rotation of the key member 16. A hexagonal recess for receiving a hexagonal tool head is shown in FIGS. 4 and 6, but other types of recesses for receiving other types of tool heads may also be used. As shown in FIGS. 4 and 5, the proximal end 34 is supported by the washer 18 such that the proximal end 34 is rotatable about the central axis.

In one form, as shown in FIGS. 1, 4, 6, and 7, a cup-shaped washer 18 may be used. In this form, the washer 18 includes a substantially flat base portion 40 that engages spring 20 when the fastener assembly is in a fastened position. The washer 18 also preferably includes a protruding portion 42 that extends longitudinally from the base portion 40 in a direction parallel to the central axis and that preferably extends upwardly to the same height as the proximal end 34. As can be seen in FIG. 1, the base portion 40 and protruding portion 42 are preferably annular in cross-section with centers along the central axis but have different annular dimensions. More specifically, the base portion 40 and protruding portion 42 preferably have substantially the same outer diameters, but the inner diameter of the base portion 40 is less than the inner diameter of the protruding portion 42. The protruding portion 42 helps keep the fastener assembly 10 centered as force is exerted downwardly against the assembly 10, as described further below.

Other types of washers may also be used. For example, a conventional, relatively flat ring-shaped washer without a protruding portion 42 may be used. The washer 18 and proximal end 34 may have other shapes as long as the proximal end 34 is supported by the washer 18 such that it is freely rotatable about the central axis.

The springs 20, 22, 24 are biased to allow the key member 16 and the washer 18 to be moveable longitudinally in a direction parallel to the central axis C-C. The springs 20, 22, 24 are biased to allow the fastener assembly 10 to move between a first fastened position and a second unfastened position. More specifically, in the first position, the springs 20, 22, 24 are relatively uncompressed and the distal end 26 is positioned above or within the apertures 28, 30, while in the second position, the springs 20, 22, 24 are relatively compressed and the ends 26, 34 are positioned on opposite sides of the apertures 28, 30.

As shown in FIG. 4, the springs 20, 22, and 24 are preferably shaped so that they are retained on the shaft 32 between the distal end 26 and the base portion 40 of the washer 18. In the preferred embodiment, as shown in FIG. 1, three Belleville spring washers have been stacked vertically atop one another for use as springs 20, 22, 24. The springs 20, 22, 24 shown in FIG. 1 each define a truncated conical portion with springs 20 and 24 oriented in an upright position and with spring 22 oriented in an inverted position. Further, the springs 20, 22, 24 shown in FIG. 1 define orifices 44, 46, 48, respectively, having centers located along the central axis and that accommodate the insertion of the shaft 32 therethrough.

Other numbers and types of springs, washers, and combinations thereof may be used, including, for example, helical compression springs. The washer 18 and springs 20, 22, 24 may be one integral component, i.e., form one integral body, or may be two discrete components operatively coupled together. Conventional forms of biasing, such as elastomer straps or resiliently deformable substances, may also be used. For purposes of this description, the term “spring” is used to refer to all such conventional forms of biasing.

Another aspect of the invention is a method for inserting and actuating the fastener assembly 10. Initially, apertures 28, 30 are formed in each of two objects 12, 14 and the apertures 28, 30 are aligned. The apertures 28, 30 are preferably in the shape of rectangular slots, although other shapes may also be used. The apertures 28, 30 are dimensioned such that they have a width and length to accommodate insertion of the distal end 26 having a rectangular cross-section therethrough but do not accommodate the distal end 26 when it is rotated with respect to the apertures 28, 30, as shown in FIG. 2.

The fastener assembly 10 is initially positioned on a top surface 50 of the top object 12. The key member 16 is oriented such that the distal end 26 is aligned with the apertures 28, 30. In this position there is no interference with the longitudinal movement of the member 16. The springs 20, 22, 24 shown in FIG. 1 are positioned with the lower end 52 of the lowermost spring 24 engaging the top surface 50 of the top object 12 and are in a relatively uncompressed state such that the upper end 54 of the uppermost spring 20 urges the washer 18 upwardly.

A pushing tool is then preferably used to force the washer 18 downwardly against the bias of the springs 20, 22, 24 to compress the springs 20, 22, 24. The washer 18 is forced downwardly and the distal end 26 is inserted through and beneath the apertures 28, 30. A tool head is then preferably inserted through the center of the pushing tool with the tool head being inserted into the recess 38 in the proximal end 34. The tool head is preferably used to rotate the proximal end 34 through a predetermined angle such that that distal end 26 is no longer aligned with the apertures 28, 30. Preferably, the proximal end 34 is rotated 90° such that the distal end 26 is perpendicular to the length of the apertures 28, 30.

The pushing tool is preferably in the shape of an annular rod having the same outer diameter as the washer 18. The annular rod has a hollow interior so as to accommodate insertion of a tool head to access the recess 38 and rotate the key member 16. The tool head is preferably positioned at the end of a shaft having sufficient length and shape to allow the tool head to be inserted through the interior of the annular rod and controlled remotely. The nature of the pushing tool depends on the amount of force required to compress the springs 20, 22, 24. If a relatively small amount of force is required, the pushing tool may be operated manually to compress the springs 20, 22, 24. On the other hand, if a relatively large amount of force is required, the pushing tool may require the use of a robotic arm or similar device to generate sufficient force. Use of the pushing tool allows for remote handling of the fastener assembly 10. In addition, it is contemplated that the pushing tool and fastener assemblies 10 could be easily adapted for use in an automated setting, such as for use on a production line.

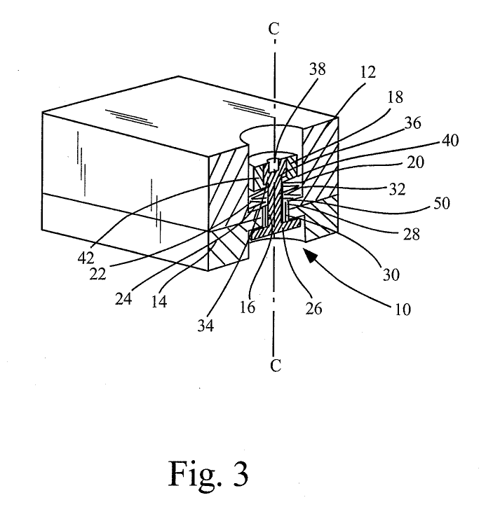

The force exerted by the pushing tool against the washer 18 is then released. With the pushing tool no longer providing a downwardly force, the compressed springs 20, 22, 24 are biased upwardly against the washer 18, which in turn is biased upwardly against the proximal end 34. This upward force is transmitted to the non-aligned distal end 26, which is urged upwardly against a bottom surface 56 of the bottom object 14, thereby fastening the top and bottom objects 12, 14 together. The springs 20, 22, 24 and the distal end 26 urge the two objects 12, 14 together along a direction parallel to the central axis. Accordingly, the fastener assembly 10 joins the two objects 12, 14 together, as shown in FIGS. 1 and 3.

Optionally, the fastener assembly 10 may make use of a locking feature to reduce the risk that the fastener assembly 10 may be inadvertently shifted from a fastened position to an unfastened position. More specifically, a recess 58 may be formed in the bottom surface 56 of the bottom object 14 to more securely hold the distal end 26 and to limit rotational movement of the distal end 26 when the fastener assembly 10 is in the fastened position. This recess 58 would conform to the position of the distal end 26 after the distal end 26 has been rotated following insertion. Once the springs 20, 22, 24 are released from their compressed state, the distal end 26 would lie within the recess 58, thereby “locking” the fastener assembly 10 in place.

Once secured, the fastener assembly 10 may be unfastened in a fairly straightforward manner involving little torque. The pushing tool described above may be used to exert force against the washer 18 and springs 20, 22, 24, thereby compressing the springs 20, 22, 24 and releasing tension between the distal end 26 and the bottom surface 56. The tool head may then be used to rotate the member 16 such that the distal end 26 is in alignment with the apertures 28, 30. The springs 20, 22, 24 may then be allowed to expand, thereby causing the distal end 26 to move into and through the apertures 28, 30 and unfastening the two objects 12, 14 from one another.

Actuation of the fastener assembly 10 requires very little torque relative to other fastening methods. Instead of using torque to position a fastener, the fastener assembly 10 makes use of the downwardly applied force of the pushing tool to appropriately position the fastener assembly 10 with respect to the two objects 12, 14 to be joined. Once the springs 20, 22, 24 are compressed and the distal end 26 is inserted through the apertures 28, 30, only a small application of torque is required to rotate the distal end 26 to a non-aligned position. Indeed, if the key member 16 does not rotate when a low torque is applied (and instead requires a high torque), this torque amount is a good indicator and diagnostic of a problem that needs to be resolved, especially for remote handling and blind installation circumstances as shown and described herein.

In addition, the fastener assembly 10 does not require the variable and inconsistent application of torque that is inherent in the use of other types of fasteners. Instead, the fastener assembly 10 makes use of the springs 20, 22, 24 to allow the application of a consistent and predetermined preload. This consistency reduces the risk of preloads that are lower or higher than desired. For example, it reduces the risk of joint failure from low preloads and the risk of damage to the fastener assembly or the objects that might otherwise result from high preloads. Further, the preload between the two objects 12, 14 may be easily tailored through the selection of springs 20, 22, 24 having a desired spring constant for the work being performed.

The fastener assembly 10 and method described above provide additional advantages. The fastener assembly 10 has a low mass relative to conventional fasteners, which is advantageous in applications where it is desirable to reduce material that may capture heat such as involving fusion devices. In such applications, the fastener assembly 10 is preferably made of high temperature/high strength material, such as stainless steel or titanium alloy. Also, it is advantageous for applications where the fastener assembly 10 is to be handled remotely and/or where the fastener assembly 10 should be relatively lightweight or fairly quick and easy to fasten and/or unfasten, such as, for example, in aircraft, missile, and fission systems. Further, use of the fastener assembly 10 reduces the likelihood of galling, the tendency of two similar metals to self weld, that is common with conventional high torque fasteners.

The foregoing relates to preferred exemplary embodiments of the invention. It is understood that other embodiments and variants are possible which lie within the spirit and scope of the invention as set forth in the following claims.

What is claimed is:

1. A fastener assembly for fastening two objects having apertures therethrough, the fastener assembly comprising:
a key member having a central axis about which the key member is capable of rotation, the key member having a first end and a second end;
a washer defining an opening therethrough for receiving a portion of the key member; and
at least one spring that is operatively coupled to the second end and that is biased to move longitudinally in a direction parallel to the central axis;
wherein the second end is supported by the washer and is capable of rotation about the central axis.

2. The fastener assembly of claim 1 wherein the fastener assembly is moveable between a first unfastened position, in which the at least one spring is substantially uncompressed and the first and second ends of the fastener assembly are not positioned on opposite sides of the apertures, and a second fastened position, in which the at least one spring is at least partially compressed and the first and second ends are on opposite sides of the apertures.

3. The fastener assembly of claim 1 wherein the key member further comprises a shaft, the shaft received within the washer opening and joining the first and second ends of the key member.

4. The fastener assembly of claim 3 wherein the shaft has a circular cross-section with a center located along the central axis.

5. The fastener assembly of claim 4 wherein the at least one spring each define an orifice therethrough for insertion of the shaft.

6. The fastener assembly of claim 5 wherein the at least one spring is retained on the shaft between the first end and the washer.

7. The fastener assembly of claim 1 wherein the washer and the at least one spring form one integral body.

8. The fastener assembly of claim 2 wherein the washer includes an annular base portion in engagement with at least one spring when the fastener assembly is in the second fastened position.

9. The fastener assembly of claim 8 wherein the washer further includes an annular protruding portion extending longitudinally from the base portion in a direction parallel to the central axis and capable of receiving a force exerted against the washer in the longitudinal direction.

10. The fastener assembly of claim 9 wherein the base portion and protruding portion have substantially the same outer diameters and wherein the inner diameter of the base portion is less than the inner diameter of the protruding portion.

11. The fastener assembly of claim 1 wherein the second end of the key member has a cross-section that is larger than the washer opening to position at least a portion of the washer between the second end and the at least one spring.

12. The fastener assembly of claim 1 wherein the key member is substantially symmetrical about the central axis.

13. The fastener assembly of claim 1 wherein the first end defines a substantially rectangular cross-section and is perpendicular to the shaft.

14. The fastener assembly of claim 1 wherein the second end has a recess therein for insertion of a tool head for rotation of the key member.

15. The fastener assembly of claim 1 wherein the first end is shaped such that it is capable of movement into and through the apertures when aligned with the apertures but is not capable of movement into and through the apertures when not in alignment.

16. The fastener assembly of claim 2 wherein the first end is shaped for insertion into a recess to limit rotational movement of the key member when the fastener assembly is in the second fastened position.

17. A method of fastening two objects together comprising:
aligning apertures of the two objects;
positioning a fastener assembly having a key member with a first end and a second end, a washer and at least one spring such that at least one spring is in abutting engagement with one of the objects and such that the first end is aligned with the apertures, wherein the second end is supported by the washer and the second end is operatively coupled to the at least one spring such that the second end and the at least one spring are moveable in a direction parallel to a central axis of rotation of the key member;
applying a force against the washer to compress the at least one spring and to cause the first end to be inserted through the apertures;
rotating the key member about the central axis such that the first end is not aligned with the apertures; and
releasing the force applied to the washer such that the first end engages the other one of the objects and thereby causing the at least one spring and the first end to urge the two objects together along a direction parallel to the central axis.

18. The method of claim 17 further comprising the step of locking the first end so as to resist rotational movement by inserting the first end in a recess formed in one of the two objects.

19. The method of claim 17 wherein the key member is caused to be rotated through the application of a low torque to the second end of the key member.

20. The method of claim 17 further comprising selecting the spring constant of the at least one spring to apply a predetermined preload between the two objects.
